(19) United States
(12) Patent Application Publication
(10) Pub. No.: US 2013/0104706 A1
(43) Pub. Date: May 2, 2013

(54) METHOD FOR PROCESSING AN INNER FACE OF A HOUSING HAVING AN OPENING

(71) Applicant: Herbert Maringer, Sattledt (AT)

(72) Inventor: Herbert Maringer, Sattledt (AT)

(73) Assignee: WFL MILLTURN TECHNOLOGIES GMBH & CO. KG, Linz (AT)

(21) Appl. No.: 13/697,412

(22) PCT Filed: May 12, 2011
(86) PCT No.: PCT/AT11/00226

§ 371 Date: Jan. 2, 2013

(30) Foreign Application Priority Data
May 12, 2010 (AT) A 804/2010

(51) Int. Cl. B23B 29/12; B23B 1/00

(52) U.S. Cl. CPC B23B 29/12; B23B 1/00
USPC 82/1.11; 82/1.2

(57) ABSTRACT

A method for processing an inner face of a housing having an opening, in particular a housing of a driving mechanism, by means of a machine tool, which has a multiaxially movable tool retainer. A tool retained by the tool retainer is introduced through the opening into the housing, which is stationary relative to the machine tool, and the tool is moved along a circular path and in the direction of the housing in order to process the inner face. In order to create advantageous method conditions, the control head of the tool retainer that accommodates the tool is driven in a rotational manner by means of an angle drive on the tool retainer in order to move the tool independently of the axes of motion of the machine tool along a circular path in order to process the inner face.

### TECHNICAL FIELD

The invention relates to a method for machining an inner surface of a housing having an opening, particularly a housing of a drive mechanism, using a machine tool that has a tool holder that can move in multiple axes, in which a tool accommodated by the tool holder is introduced into the housing, which is fixed in place relative to the machine tool, through the opening, and moved along a circular path and in the direction of the housing to machine the inner surface.

### STATE OF THE ART

In order to be able to machine the inner surface of a drive mechanism housing, it is known from the state of the art to apply a tool to the inner surface to be machined, and to move it along a circular path and in the direction of the housing, in order to thereby achieve a desired removal of material from the housing. For this purpose, the tool accommodated by a tool holder is introduced into the housing by way of an opening of the housing, preferably without making contact, and put into rotation along linear movement axes, in order to thereby be able to guide the tool along a circular path. Using a further movement axis of the machine tool, the tool is then displaced in the direction of the housing, in order to be able to create cylindrical turned surfaces, for example. It is disadvantageous, in connection with such machining, that it is not possible to achieve comparatively great dimensional precision and surface quality, because of the tolerances of the different movement axes of the multi-axis machine tool, particularly also because the stress on the axes of the machine tool during machining can be significant. Repeated reworking must therefore be considered, and often the use of molding tools is also required, which can lead to cost-intensive and therefore uneconomical methods.

Furthermore, a portable machine tool for repairing kickback valves is known from the state of the art (WO91/17013A1). The machine tool is pushed into an opening of the valve, firmly connected with the valve mechanically there, and has a machining head that is mounted to be adjustable in accordance with the inner surface of the valve to be machined. WO91/17013A1 cannot disclose an improvement in the machining of work pieces using a machine tool that has a tool holder that can move in multiple axes to a person skilled in the art.

Presentation of the Invention

The invention has therefore set itself the task of improving a method for machining an inner surface of a housing of a drive mechanism, using a machine tool having a tool holder that can move in multiple axes, of the type described initially, in such a manner that it can be used to ensure machining in fast, simple, and highly precise manner.

The invention accomplishes the stated task, with regard to the method, in that the actuating head of the tool holder that accommodates the tool is driven to rotate by way of an angled drive on the tool holder, in order to move the tool along a circular path, to machine the inner surface, independent of the movement axes of the machine tool.

If the actuating head of the tool holder that accommodates the tool is driven to rotate by way of an angled drive on the tool holder, then first of all, a method that is easy to handle can be created, because the tool can be introduced into an opening of the housing of the drive mechanism in simple manner, using such a tool holder, and also an inner surface that is inclined relative to the opening side of the housing can be machined. However, it is particularly advantageous that as a result, the tool can be moved or guided along a circular path, for machining the inner surface, independent of the movement axes of the machine tool. In this way, it can be guaranteed, among other things, that at least the circular path of the tool is not subject to the tolerances of the movement axes of the machine tool, so that in contrast to the state of the art, a high level of dimensional precision and surface quality can be achieved, at least with regard to the circular path. Particularly because slight stresses and therefore tolerances in guidance precision can be expected between actuating head and tool itself, because of the comparatively low mass. The method according to the invention can therefore ensure machining, quickly and at high precision, something that a stable method can always guarantee. Furthermore, the risk of damage to the inner surface of the housing, as the result of undesired contact with the tool holder, can be avoided by means of not necessarily utilizing the movement axes of the machine tool. Freedom from contact of a tool holder introduced into the opening, particularly in contact-free manner, can therefore be ensured even when machining the inner surface of the housing by means of the tool, so that a particularly stable method can be guaranteed.

It does not have to be further mentioned that known actuating heads can make a position of the tool offset relative to the axis of rotation of the actuating head, by means of mechanical adjustment mechanisms. Such adjustment mechanisms can allow eccentric or linear displacements of the tool on the actuating head. Actuating heads are also known as actuating tools in the state of the art.

Advantageous method conditions can result, with regard to improved precision, if the tool is connected with the actuating head in torque-proof manner, during machining of the inner surface along the circular path. Specifically then, an interruption of the circular cut of the tool is avoided, thereby making reduced modulation of the cutting force possible, as compared with known rotating milling tools. Furthermore, the reduced tendency to vibrate of such a tool connected in torque-proof manner can be utilized to achieve reduced wear as well as special dimensional precision and surface quality. It does not have to be mentioned further that after machining of the circular path, it is, of course, possible to change the radius of the circular path, in order to guide the tool along a changed circular path during the next cut.

A lathe bore tool has particularly proven itself as a tool for the method according to the invention, in order to thereby be able to take increased precision values into account.

To implement the method for machining the inner surface of a housing of a drive mechanism, it can be particularly advantageous if an actuating head that is driven to rotate by way of an angled drive, for accommodating a tool, particularly a lathe bore tool, is used on a machine tool.

It is furthermore the task of the invention to create a tool holder that is particularly simple to handle, with which the method according to the invention can be improved.

The invention accomplishes this task, with regard to the tool holder, in that the actuating head follows a slim shaft, by way of an angled drive.

If the actuating head follows a slim shaft by way of an angled drive, then the tool can be introduced in simple manner, even in the case of comparatively small openings in the housing. Specifically, the slim shaft can particularly ensure a low construction height of the tool holder, and can also serve to reach low-lying regions of the inner surface of the housing.

If the tool holder has a further drive flange for adjusting the position of the tool accommodation on the actuating head, then the radius of the circular-path can be adjusted in comparatively simple manner.

### BRIEF DESCRIPTION OF THE DRAWING

In the figures, the object of the invention is shown as an example, using an exemplary embodiment. The figures show:

FIG. 1 a side view of the machine tool, with the housing clamped in place,

FIG. 2 a side view according to FIG. 1, with the tool of the machine tool in engagement with the housing, and

FIG. 3 a partially complete top view of the machining point according to FIG. 2.

### WAY OF IMPLEMENTING THE INVENTION

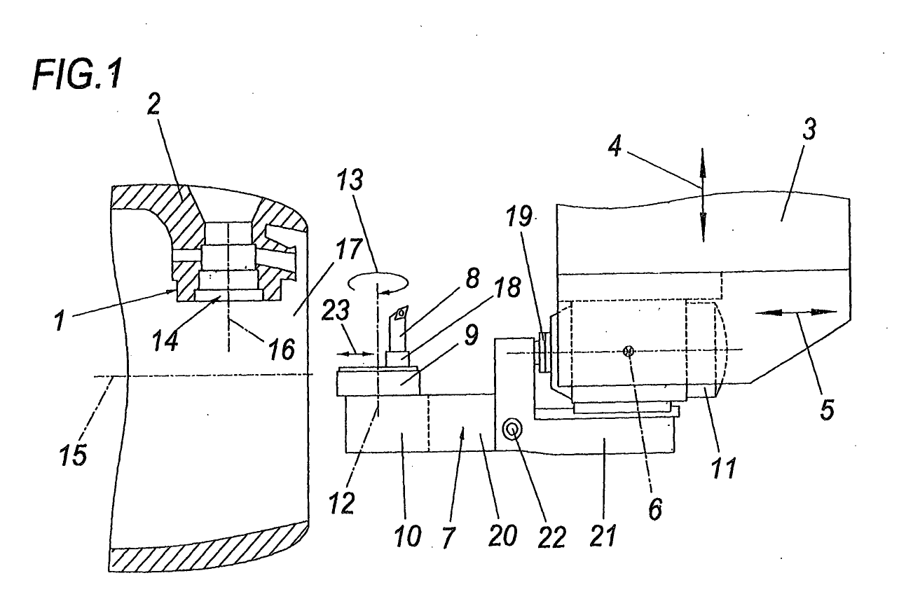

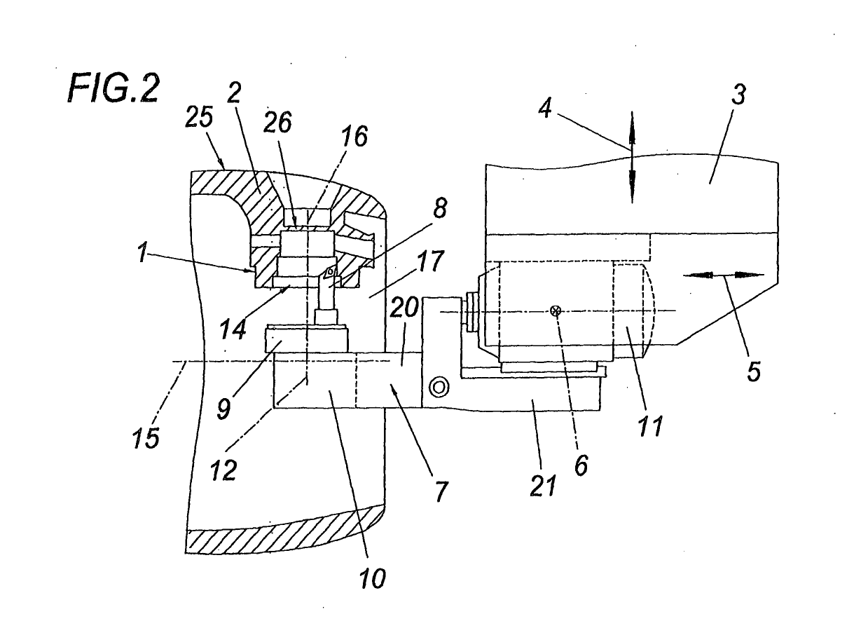

The method according to the invention is explained as an example according to FIGS. 1, 2, and 3. Thus, according to FIG. 1, the inner surface 1 of a housing 2 of a drive mechanism is shown, which is firmly clamped onto a machine tool 3, shown only in part, for machining. The machine tool 3 has multiple axes 4, 5, and 6, whereby the axes 4 and 5 are linear axes and the axis 6 represents an axis of rotation and also a slide axis, using which axes 4, 5, and 6 a tool holder 7 can be moved. A tool 8, particularly a lathe tool, lathe bore tool, drill-finishing tool or drill-finishing head is provided on the tool holder 7, for machining of the inner surface 1. The tool is introduced into the housing 2 by way of an opening 17 of the housing 2, particularly without making contact, by means of moving the tool holder 7 by way of the axes 4, 5, and 6. Damage to the inner surface of the housing caused by the tool holder 7 can thereby be avoided. In order to allow advantageous machining of the inner surface 1, the tool holder 7 has an actuating head 9 that is mounted to rotate on the tool holder 7. This actuating head 9 can be put into rotation by a drive 11 provided on the machine tool 3. A tool 8 attached to the actuating head 9 outside the center of the axis of rotation 12 can thereby be moved on a circular path 13 or guided along it in particularly precise manner. This circular path 13 is specifically independent of the movement axes 4, 5, and 6 of the machine tool, leading to extremely high dimensional precision and surface quality on the housing 2 or its inner surface 1, if a bore 14, for example, must be machined or reworked from the inside toward the outside of the housing 2, which machining is shown in FIG. 2, for example. Thus, the radius of the circular path 13 corresponds precisely to the eccentricity of the tool 8 on the actuating head 9 or relative to the axis of rotation 12. Tolerances of the movement axes 4, 5, and 6 of the machine tool 3 do not play any role in such machining, so that in contrast to the state of the art, great accuracy and precision can be guaranteed.

In order to now create cylindrical machining, for example, the tool holder 7 or the tool 8 merely has to be adjusted at the required angle relative to the introduction axis 15, and then displaced in the direction of the machining axis 16. In this case, the machining axis 16 is parallel to the axis 4 of the machine tool—however, any inclined position of the machining axis 16 relative to the introduction axis 15 is possible.

A tool 8 that is connected with the actuating head 9 in torque-proof manner when the inner surface 1 is machined along the circular path 13 has proven to be particularly advantageous for machining of the inner surface 1. The tool 8 therefore does not perform any rotation about its axis of symmetry during machining, which can ensure a particular cut on the housing 2, in order to thereby be able to ensure a high level of dimensional precision and surface quality.

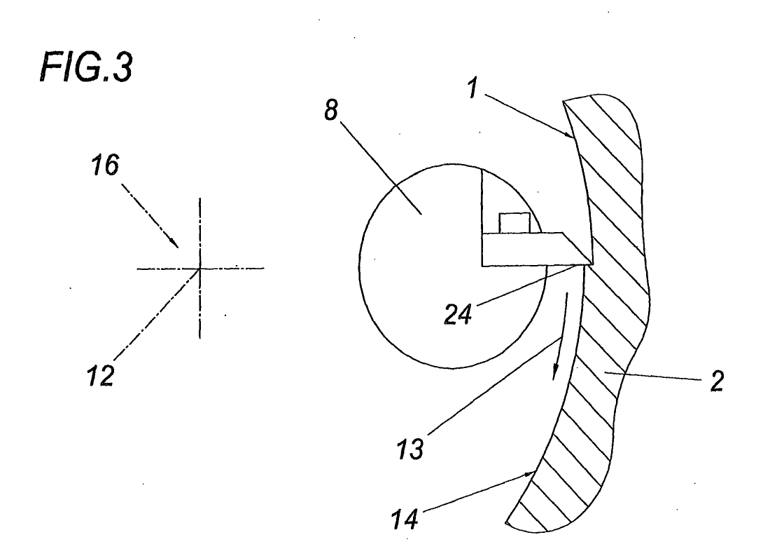

In particular, in FIG. 3, a lathe bore tool is shown as a tool, which is moved along the circular path 13 with its cutting blade 24, namely, according to the invention, using the actuating head 9.

In general, it should be mentioned that in particular, turned surfaces of bores 14, for example, can be machined in simple and precise manner by means of such a circular path 13.

In order to be able to introduce a tool 8 through an opening 17 of a drive mechanism, in particular, a special tool holder 7 is proposed according to FIGS. 1 and 2, which has a tool accommodation 18, an actuating head 9 that follows the tool accommodation 18, and a drive flange 19 for connecting the drive 11. The rotational movement of the actuating head 9 is produced by way of the drive 11, in order to move the tool accommodation 18 on the actuating head 9 or the tool 8 or its cutting blade 24 about a circular path 13. The tool holder 7 also has a clamping part 21 in order to thereby create an attachment to the machine tool. The configuration of the tool holder is particularly advantageous in that the actuating head 9 follows a slim shaft 20, by way of an angled drive 10, thereby making it possible to introduce the tool 8 also into comparatively deep zones of the housing 2, for machining.

The tool holder 7 furthermore has another drive flange 22, in order to thereby be able to adjust the position 23 of the tool accommodation 18 on the actuating head 9. In this way, a comparatively flexible tool holder 7 can be created, which can be adapted to different circular paths 13 in comparatively simple and rapid manner, thereby also making it possible to improve the machining method in faster and therefore improved manner.

Furthermore, any turned surfaces, for example a circular cone, can be produced with the position 23, using synchronization, taking movements of the movement axes 4, 5, and/or 6 into consideration.

It does not have to be mentioned further that it is possible to machine not only bores 14 on the housing 2, using the method according to the invention. It is also possible to introduce other structures into the inner surface 1 of the housing 2, as shown, for example, in FIG. 2. There it is clearly evident that a crosspiece 26 is provided between the recesses on the outer surface 25 of the housing 2 and the structure 14 on the inner surface 1 of the housing 2.

1-6. (canceled)

7. Method for machining an inner surface (1) of a housing (2) having an opening (17), particularly a housing of a drive mechanism, using a machine tool (3) that has a tool holder (7) that can move in multiple axes, in which a tool (8) accommodated by an actuating head (9) of a tool holder (7) is introduced into the housing (2), which is fixed in place relative to the machine tool (3), through the opening (17), along an introduction axis (15), and moved along a circular path (13) and in the direction of the housing (2), along a machining axis (16), to machine the inner surface (1), characterized in that the actuating head (9) of the tool holder (7) is driven to rotate by way of an angled drive (10) of the tool holder (7), in order to move the tool (8) along a circular path (13), to machine the inner surface (1), independent of the movement axes (4, 5, 6) of the machine tool (3), and along a machining axis (16) that is inclined relative to the introduction axis (15).

8. Method according to claim 7, wherein the tool (8) is connected, in torque-proof manner, with the actuating head (9), during machining of the inner surface (1) along the circular path (13).

9. Method according to claim 8, wherein a lathe bore tool is used as the tool (8) for machining of the housing (2).

10. Use of a tool holder (7) having an angled drive (10) and having an actuating head (9) driven to rotate by way of the angled drive (10), for accommodating a tool (8), particularly a lathe bore tool, in a machine tool (3) for machining of an inner surface (1) of a housing (2) of a drive mechanism.

11. Tool holder having a tool accommodation (18), having an actuating head (9) that follows the tool accommodation (18), and having a drive flange (19) for moving the tool accommodation (18) on the actuating head (9) about a circular path (13), and having a clamping part (21) for attaching the tool holder (7) to a machine tool (3), characterized in that the tool holder (7) has an angled drive (10) and a slim shaft (20), and that the actuating head (9) driven to rotate by the angled drive (10) follows the slim shaft (20), by way of the angled drive (10).

12. Tool holder according to claim 11, wherein the tool holder (7) has a further drive flange (22) for adjusting the position (23) of the tool accommodation (18) on the actuating head (9).
